(19) United States
(12) Patent Application Publication
(10) Pub. No.: US 2026/0224977 A1
(43) Pub. Date: Aug. 6, 2026

(54) PRIZE-ACQUISITION GAME DEVICE

(71) Applicant: SEGA CORPORATION, Tokyo (JP)

(72) Inventors: Riho Takikawa, Tokyo (JP); Shinpei Nomura, Tokyo (JP); Mitsuharu Fukazawa, Tokyo (JP); Takaya Goshozono, Tokyo (JP)

(73) Assignee: SEGA CORPORATION, Tokyo (JP)

(21) Appl. No.: 19/631,267

(22) Filed: Mar. 27, 2026

Related U.S. Application Data
(63) Continuation of application No. PCT/JP2024/018184, filed on May 16, 2024.

(30) Foreign Application Priority Data
Sep. 29, 2023 (JP) 2023-170941

(51) Int. Cl. A63F 9/30; G07F 17/32

(52) U.S. Cl. CPC A63F 9/30; G07F 17/3297; A63F 2250/144

(57) ABSTRACT

A prize-acquisition game device includes: a casing that houses prizes; first and second prize catchers that are respectively disposed in a left-side first play area and a right-side second play area adjacent in a lateral direction within the casing and that acquire the housed prizes; a central processing unit (CPU) that sets a boundary position between the first play area and the second play area based on a setting operation by an operator; and an illumination device that emits light to a first light-emitting area corresponding to the first play area and a second light-emitting area corresponding to the second play area, and change the first light-emitting area and the second light-emitting area depending on the set boundary position.

### BACKGROUND

### Technical Field

The present invention relates to a prize-acquisition game device.

### Description of Related Art

There are known prize-acquisition game devices that cause a player to play a game to obtain a prize housed in a casing that houses prizes (for example, Patent Document 1).

### Patent Documents

Patent Document 1 JP 2019-98076 A

### Technological Problem to Be Solved by Invention

The prize-acquisition game device described in Patent Document 1 forms a first play area on the left side of a casing where a player plays a prize-acquisition game, and forms a second play area on the right side thereof. In the first play area and the second play area, a prize-acquisition unit disposed in each of the first play area and the second play area is movable. In a case where a structure in which the sizes of the first play area and the second play area can be changed within the casing is adopted, there is a risk that it may be difficult to ascertain the respective sizes thereof by just looking at them.

### Summary

One or more embodiments of the present invention easily ascertain the size of each of the first play area and the second play area.

According to one aspect of the present invention, a prize-acquisition game device comprises a casing that houses prizes; first and second prize catchers that are respectively disposed in a left-side first play area and a right-side second play area adjacent in a lateral direction within the casing and that acquire the housed prizes; a central processing unit (CPU) that sets a boundary position between the first play area and the second play area based on a setting operation by an operator; and an illumination device that emits light to a first light-emitting area corresponding to the first play area and a second light-emitting area corresponding to the second play area, and change the first light-emitting area and the second light-emitting area depending on the set boundary position.

Other features of the present invention will become apparent from the description of the present specification and the accompanying drawings.

### BRIEF DESCRIPTION OF DRAWINGS

FIG. 1 is an external view illustrating a configuration of a prize-acquisition game device 1 according to one or more embodiments.

FIG. 2 is a schematic perspective view illustrating a configuration of the prize-acquisition game device 1 according to one or more embodiments.

FIG. 3 is a block diagram illustrating a configuration of the prize-acquisition game device 1 according to one or more embodiments.

FIG. 4 is a schematic view illustrating the configuration of a prize-acquisition unit (or prize catcher) 20 according to one or more embodiments.

FIG. 5 is a schematic perspective view illustrating a configuration of a moving unit 50 according to one or more embodiments.

FIG. 6 is a top-surface side perspective view illustrating a configuration of a moving unit 50 according to one or more embodiments.

FIG. 7 is a right-surface side perspective view illustrating a configuration of a moving unit 50 according to one or more embodiments.

FIG. 8 is a schematic perspective view illustrating a configuration of a first right end actuator 532 according to one or more embodiments.

FIG. 9 is a schematic perspective view illustrating a configuration of a second left end actuator 533 according to one or more embodiments.

FIG. 10 is a flowchart explaining an operation example of the prize-acquisition game device 1 according to one or more embodiments.

FIG. 11A is an image view for explaining a case where a light-emitting area is set using a setting unit 100, and illustrating a setting screen 500 in a state in which a boundary position is selected in a case where a first play area and a second play area are set to have the same size.

FIG. 11B is a schematic front view for explaining the case where the light-emitting area is set using the setting unit 100, and illustrating the light-emitting unit 75 in a state in which a first light-emitting area LA1 and a second light-emitting area LA2 have the same size.

FIG. 11C is an image view for explaining the case where the light-emitting area is set using the setting unit 100, and illustrating a setting screen 500 in a state in which a boundary position is selected in a case where the second play area is set to be larger than the first play area.

FIG. 11D is a schematic front view for explaining the case where the light-emitting area is set using the setting unit 100, and illustrating the light-emitting unit 75 in a state in which the second light-emitting area LA2 is set to be larger than the first light-emitting area LA1.

FIG. 12 is a schematic external view illustrating a disposition state of a first right end actuator 532 and a second left end actuator 533 in a case where the second play area is set to be smaller than the first play area.

FIG. 13A is a schematic plan view for explaining a case where a light-emitting area is set using the first right end actuator 532 and the second left end actuator 533 and illustrating the inside of the casing in a case where a first play area PA1 and a second play area PA2 are set to the same size.

FIG. 13B is a schematic front view for explaining the case where the light-emitting area is set using the first right end actuator 532 and the second left end actuator 533, and illustrating the light-emitting unit 75 in a state in which a first light-emitting area LA1 and a second light-emitting area LA2 have the same size.

FIG. 13C is a schematic plan view for explaining the case where the light-emitting area is set using the first right end actuator 532 and the second left end actuator 533 and illustrating the inside of the casing in a case where the second play area PA2 is set to be smaller than the first play area PA1.

FIG. 13D is a schematic front view for explaining the case where the light-emitting area is set using the first right end actuator 532 and the second left end actuator 533, and illustrating the light-emitting unit 75 in a state in which the second light-emitting area LA2 is set to be smaller than the first light-emitting area LA1.

FIG. 14 is a schematic external view illustrating the disposition state of the partition plate 65 in a case where a first play area and a second play area are set to the same size.

FIG. 15 is a schematic external view illustrating the disposition state of the partition plate 65 in a case where the second play area is set to be larger than the first play area.

FIG. 16A is a schematic plan view for explaining a case where a light-emitting area is set using the partition plate 65, and illustrating the inside of the casing in a case where the first play area PA1 and the second play area PA2 are set to the same size.

FIG. 16B is a schematic front view for explaining the case where the light-emitting area is set using the partition plate 65, and illustrating the light-emitting unit 75 in a state in which the first light-emitting area LA1 and the second light-emitting area LA2 have the same size.

FIG. 16C is a schematic plan view for explaining the case where the light-emitting area is set using the partition plate 65, and illustrating the inside of the casing in a case where the second play area PA2 is set to be larger than the first play area PA1.

FIG. 16D is a schematic front view for explaining the case where the light-emitting area is set using the partition plate 65, and illustrating the light-emitting unit 75 in a state in which the second light-emitting area LA2 is set to be larger than the first light-emitting area LA1.

FIG. 17 is a schematic perspective view illustrating a configuration of an actuator 535 according to one or more embodiments.

### DETAILED DESCRIPTION OF EMBODIMENTS

At least the following will become apparent from the description of this specification and the accompanying drawings.

Specifically, a prize-acquisition game device includes: a casing that houses prizes, first and second prize catchers that are disposed respectively in a left-side first play area and a right-side second play area adjacent in a lateral direction within the casing and that acquire the housed prizes;

a central processing unit (CPU) that sets a boundary position between the first play area and the second play area based on a setting operation by an operator; and an illumination device that emits light to a first light-emitting area corresponding to the first play area and a second light-emitting area corresponding to the second play area, and change the first light-emitting area and the second light-emitting area depending on the set boundary position.

According to such a prize-acquisition game device, when the boundary position between the first play area and the second play area is set according to a setting operation by an operator, the first light-emitting area and the second light-emitting area are changed to match the boundary position. Therefore, by looking at the light-emitting state of the first light-emitting area and the second light-emitting area, the size of each of the first and second play area can be easily ascertained.

In addition, a prize-acquisition game device includes: a casing that houses prizes; first and second prize catchers that are respectively disposed in a left-side first play area and a right-side second play area adjacent in a lateral direction within the casing and that acquire the housed prizes;

a position detector that detects at least one of a right end position of the first play area and a left end position of the second play area;

a central processing unit (CPU) that sets a boundary position between the first play area and the second play area based on at least one of the right end position and the left end position; and an illumination device that emits light to a first light-emitting area corresponding to the first play area and a second light-emitting area corresponding to the second play area, and change the first light-emitting area and the second light-emitting area depending on the set boundary position.

According to such a prize-acquisition game device, when the boundary position between the first play area and the second play area is set by detecting at least one detection of position of the right end position of the first play area and the left end position of the second play area, the first light-emitting area and the second light-emitting area are changed to match the boundary position. Therefore, by looking at the light-emitting state of the first light-emitting area and the second light-emitting area, the size of each of the first play area and the second play area can be easily ascertained.

In addition, a prize-acquisition game device includes: a casing that houses prizes; first and second prize catchers that are respectively disposed in a left-side first play area and a right-side second play area adjacent in a lateral direction within the casing and that acquire the housed prizes;

a detector that detects a position of a partition plate disposed between the first plate area and the second play area; a central processing unit (CPU) that sets a boundary position between the first play area and the second play area based on the position of the partition plate; and an illumination device that emits light to a first light-emitting area corresponding to the first play area and a second light-emitting area corresponding to the second play area, and change the first light-emitting area and the second light-emitting area depending on the set boundary position.

According to such a prize-acquisition game device, when the boundary position between the first play area and the second play area is set by detecting the position of the partition plate, the first light-emitting area and the second light-emitting area are changed to match the boundary position. Therefore, by looking at the light-emitting state of the first light-emitting area and the second light-emitting area, the size of each of the first play area and the second play area can be easily ascertained.

In addition, a prize-acquisition game device includes: a casing that houses prizes; first and second prize catchers that are respectively disposed in a left-side first play area and a right-side second play area adjacent in a lateral direction within the casing and that acquire the housed prizes; a position detector that detects at least one of a rightward movement limit position of the first prize catcher in the first play area and a leftward movement limit position of the second prize catcher in the second play area; a central processing unit (CPU) that sets a boundary position between the first play area and the second play area based on at least one of the movement limit positions of the first play area and the second play area; and an illumination device that emits light to a first light-emitting area corresponding to the first play area and a second light-emitting area corresponding to the second play area, and change the first light-emitting area and the second light-emitting area depending on the set boundary position.

According to such a prize-acquisition game device, when the boundary position between the first play area and the second play area is set by detecting at least one of the movement limit positions of the prize catchers in the first play area and the second play area, the first light-emitting area and the second light-emitting area are changed to match the boundary position. Therefore, by looking at the light-emitting state of the first light-emitting area and the second light-emitting area, the size of each of the first play area and second play area can be easily ascertained.

In addition, in such a prize-acquisition game device, the illumination device may be configured to make the light emission color of the first light-emitting area corresponding to the first play area different from the light emission color of the second light-emitting area corresponding to the second play area.

According to such a prize-acquisition game device, the size of each of the first play area and the second play area can be easily ascertained by making the light emission color of the first light-emitting area from the second light-emitting area different from the second light-emitting area.

In addition, in such a prize-acquisition game device, the illumination device may be configured to make the light emission pattern of the first light-emitting area corresponding to the first play area different from the light emission pattern of the second light-emitting area corresponding to the second play area.

According to such a prize-acquisition game device, the size of each of the first play area and the second play area can be easily ascertained by making the light emission pattern of the first light-emitting area different from the light emission pattern of the second light-emitting area.

### Embodiments

### Configuration of prize-acquisition game device 1

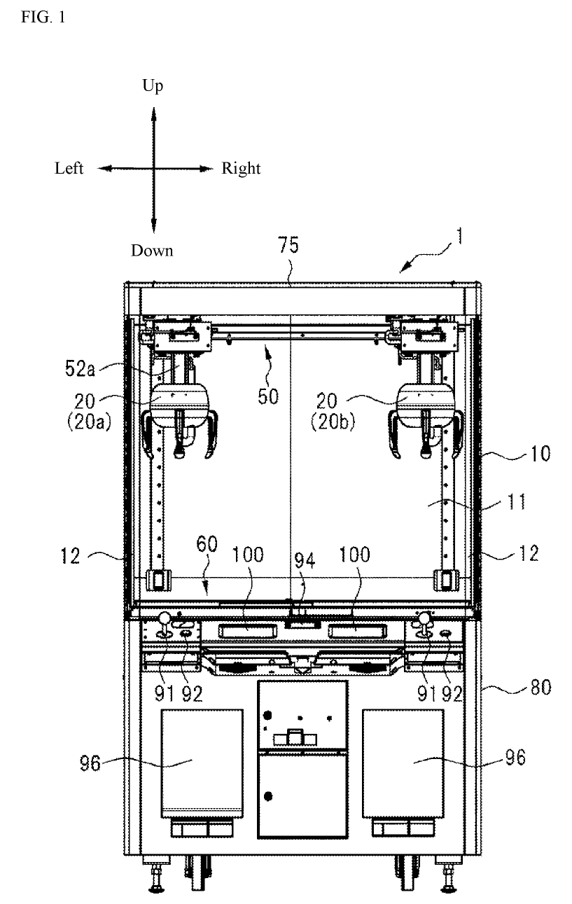

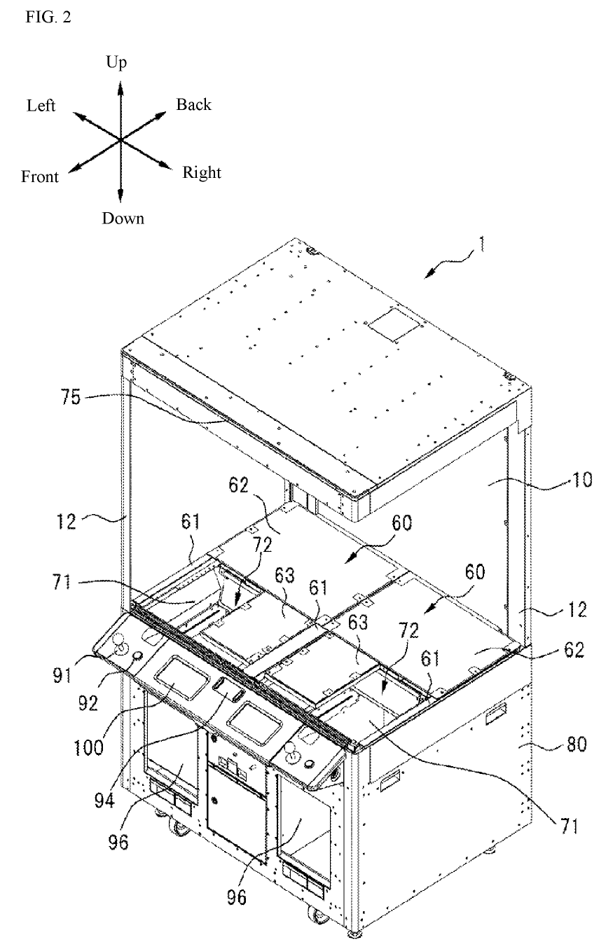

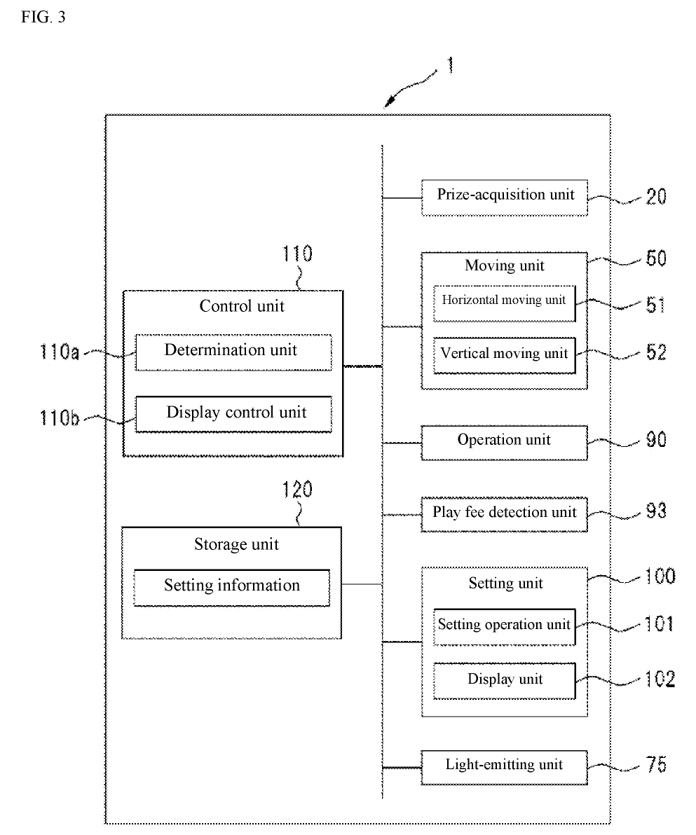

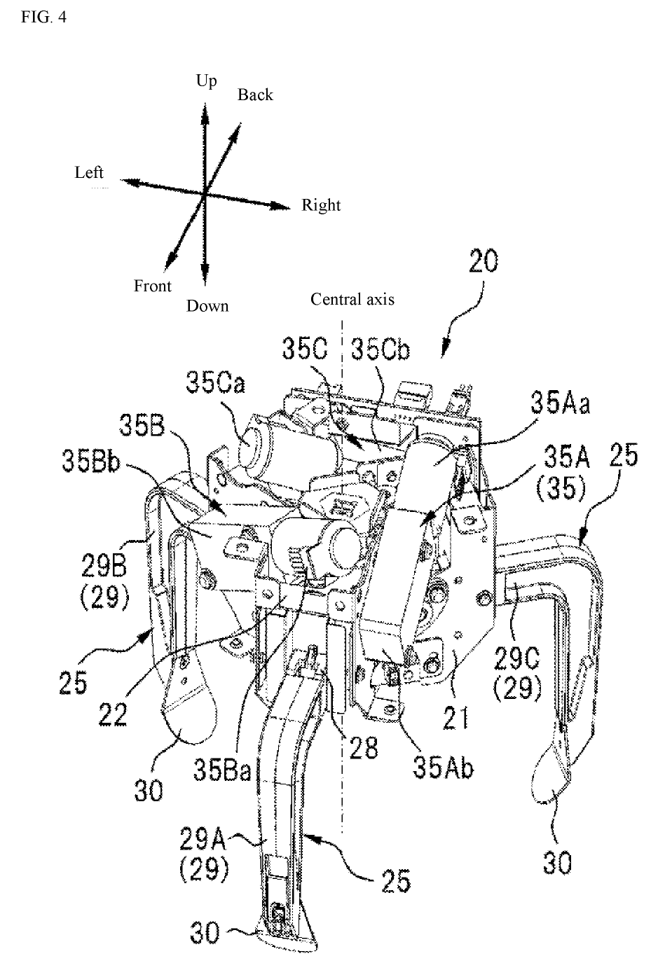

A configuration example of a prize-acquisition game device 1 according to one or more embodiments will be described with reference to FIG. 1 to FIG. 4. FIG. 1 is an external view illustrating a configuration of the prize-acquisition game device 1 according to one or more embodiments. FIG. 2 is a schematic perspective view illustrating a configuration of the prize-acquisition game device 1 according to one or more embodiments. It is noted that FIG. 2 illustrates a state in which an opening/closing door 11, part of pillar portions 12, a prize-acquisition unit (or prize catcher) 20, and the like illustrated in FIG. 1, have been removed. FIG. 3 is a block diagram illustrating the configuration of the prize-acquisition game device 1 according to one or more embodiments. FIG. 4 is a schematic view illustrating a configuration of the prize-acquisition unit 20 according to one or more embodiments. It is noted that FIG. 4 illustrates a state in which the design cover of the prize-acquisition unit 20 has been removed.

In the following description, each direction is defined as illustrated in each figure. That is, the vertical direction is defined as the "up-down direction," and "up" and "down" are defined according to gravity. In addition, the front-back direction is defined as the “front” being the front side and the “back” being the back side from the perspective of a player playing the game facing the prize-acquisition game device 1. Additionally, the direction perpendicular to the up-down and front-back directions is defined as the "left-right direction," and "right" and "left" are defined based on the view from the player's side.

The prize-acquisition game device 1 according to one or more embodiments is used when a player plays a prize-acquisition game, and is equipped with a casing 10 that houses one or more prizes, and a base portion 80 provided below the casing 10.

As illustrated in FIG. 1, the casing 10 is formed of transparent members (for example, transparent resin, glass, or the like) on a front surface and left-right side surfaces thereof so that the prize housed within the housing space can be seen by the player. The opening/closing door 11 is provided on the front surface of the casing 10, which allows a service provider (for example, store staff or the like) to display and replenish the prizes. Pillar portions 12 are provided at four corners of the casing 10.

The housing space enclosed by the casing 10 is used as a play area where a player plays the prize-acquisition game. In a case where the pillar portions 12 on both sides of the opening/closing door 11 are made of a mirror-like material or a transparent material, they will not stand out visually, making the play area look wider.

As illustrated in FIG. 1 and FIG. 2, the casing 10 in one or more embodiments has the prize-acquisition unit 20 that performs the operation of acquiring a prize in the housing space, a moving unit 50 that moves the prize-acquisition unit 20 in the housing space, and an exhibit unit 60 for displaying the prizes in the housing space.

One or more embodiments form a first play area on the left side of a housing space where a player plays a prize-acquisition game, and form a second play area on the right side of the housing space. The prize-acquisition unit 20 and the exhibit unit 60 are arranged corresponding to the first play area on the left side and the second play area on the right side, respectively. Therefore, within each play area, each prize-acquisition unit 20 is configured to move and be able to acquire prizes displayed in each exhibit unit 60.

As illustrated in FIG. 1, the prize-acquisition unit 20 in one or more embodiments has a first prize-acquisition unit (or first prize catcher) 20a corresponding to the first play area on the left side, and a second prize-acquisition unit (or second prize catcher) 20b corresponding to the second play area on the right side. The movable range of the first prize-acquisition unit 20a within the housing space is limited to within a first play area, and the movable range of the second prize-acquisition unit 20b within the housing space is limited to within a second play area.

The prize-acquisition unit 20 is for acquiring the prizes contained in the casing 10 (the prizes displayed in the exhibit unit 60) by opening and closing the arm. As illustrated in FIG. 1, the prize-acquisition unit 20 in one or more embodiments is configured so as to be able to grasp a prize by means of three arms, and is linked to a lower end of a lifting unit (or lifter) 52a.

As illustrated in FIG. 4, the prize-acquisition unit 20 according to one or more embodiments has a base portion 21 connected to the lower end of the lifting unit 52a, a plurality of arm portions 25 that perform opening and closing operations, and a drive unit (or driver) 35 that drives the arm portions 25 to open and close.

The base portion 21 has trifurcated protruding portions 22 that are offset in three directions at 120 degree intervals from a central axis along the vertical direction.

The arm portion 25 has an arm 29 bent into an L shape and a semicircle shape, an arm linking portion 28 that detachably connects the arm 29 to the base portion 21, and a claw 30 that is detachably attached to the tip of the arm 29.

The arm 29 is made up of three arms, a first arm 29A, a second arm 29B, and a third arm 29C, which extend in a trifurcated shape shifted at 120 degree intervals in three directions around the central axis of the base portion 21 so as to match the trifurcated shape of the protruding portion 22.

The drive unit 35 includes three units, a first drive unit 35 (or first driver) A, a second drive unit (or second driver) 35B, and a third drive unit (or third driver) 35C, which are provided for each arm. As illustrated in FIG. 4, the first drive unit 35A, the second drive unit 35B, and the third drive unit 35C correspond to the first arm 29A, the second arm 29B, and the third arm 29C, respectively, and drive them to open and close separately.

The first drive unit 35A has an arm opening/closing motor 35Aa, and a gearbox 35Ab connected to the arm opening/closing motor 35Aa. The gearbox 35Ab reduces the rotational force of the arm opening/closing motor 35Aa and outputs the same.

Similarly, the second drive unit 35B has an arm opening/closing motor 35Ba and a gearbox 35Bb connected to the arm opening/closing motor 35Ba, and the third drive unit 35C has an arm opening/closing motor 35Ca and a gearbox 35Cb connected to the arm opening/closing motor 35Ca.

In the prize-acquisition unit 20 according to one or more embodiments, for example, when the first arm 29A is in an open state, when the arm opening/closing motor 35Aa rotates the output shaft in a predetermined direction, power is transmitted to the first arm 29A via the gearbox 35Ab, and the first arm 29A rotates in a closing direction. At this time, the second arm 29B and the third arm 29C are also rotated in the closing direction in the same manner by the driving of the arm opening/closing motor 35Ba and the arm opening/closing motor 35Ca, respectively.

As illustrated in FIG. 1, the moving unit 50 is disposed in the upper part of the casing 10 and moves the prize-acquisition unit 20 within the play field formed by the casing 10. As illustrated in FIG. 3, the moving unit 50 in one or more embodiments has a horizontal moving unit 51 and a vertical moving unit 52.

The horizontal moving unit 51 may comprise rail(s), motor, encoder, and limit sensor, and moves the prize-acquisition unit 20 horizontally (that is, front-back and left-right) on the play area. The vertical moving unit 52 may be mounted on the rail(s), and moves the prize-acquisition unit 20 in the vertical direction (that is, the up-down direction) on the play area.

The exhibit unit 60 is for displaying the prizes in the casing 10. The exhibit unit 60 according to one or more embodiments is displayed by placing the prize in a housing space, and, as illustrated in FIG. 2, has a support portion 61, a first prize placement portion 62 that forms an opening area 71 by being disposed in the housing space, and a second prize placement portion 63 that forms a drop port area 72 that closes a portion of the opening area 71 and causes the prize to drop.

The support portion 61 supports the first prize placement portion 62 and the second prize placement portion 63 so that they can be positioned in the housing space. In one or more embodiments, the first prize placement portion 62 is fixed and supported so that it cannot be redisposed within the housing space, and the second prize placement portion 63 is supported to enable redisposition within the housing space.

The support portion 61 in one or more embodiments supports the second prize placement portion 63 below the first prize placement portion 62 in a slidable state. Therefore, by sliding the second prize placement portion 63 in the front-back direction, the second prize placement portion 63 can be redisposed with respect to the first prize placement portion 62, and the shape and size of the placement area where the prize can be placed can be changed, or the shape and size of the drop port area 72 can be changed.

The first prize placement portion 62 is fixed within the housing space, and its position cannot be changed in principle. As illustrated in FIG. 2, an area (unblocked area) within the housing space where the first prize placement portion (fixed prize placement portion) is not provided is the opening area 71.

The second prize placement portion 63 is configured to be re-deployable within the housing space, and as illustrated in FIG. 2, is supported by the support portion 61 so as to block a portion of the opening area 71 to form the drop port area 72.

When the prize that is acquired and then dropped by the prize-acquisition unit 20 passes (drops) through the drop port area 72 of the exhibit unit 60, it is considered to have moved from the play area to the base portion 80. The prize dropped from the drop port area 72 of the exhibit unit 60 is detected by an optical sensor and then guided to a prize outlet 96 via a guide path. The optical sensor detects the presence or absence of the prize by using a light-emitting unit (light emitter) and a light-receiving unit (light receiver) that are installed on the guide path.

The light-emitting unit 75 is an illumination device that emits light to the outside. The light-emitting unit 75 in one or more embodiments is disposed in the upper part on the front surface of the casing 10, as illustrated in FIG. 1 and FIG. 2. The light-emitting unit 75 is formed to a size that matches the width of the casing 10 and has a plurality of light-emitting diodes arranged in a line at predetermined intervals along the width direction (left-right direction). The light-emitting diodes are full-color LEDs (Light Emitting Diodes), and thus the light emission color can be changed.

The base portion 80 is a base portion of a casing provided below the casing 10, and holds the casing 10 at a high position so that a player can play a game while facing the front in a standing position.

As illustrated in FIG. 1 to FIG. 3, the base portion 80 in one or more embodiments has an operation unit 90, a play fee detection unit (or play fee detector) 93, a prize outlet 96, a setting unit 100, a control unit (or controller) 110, and a storage unit 120.

The operation unit 90 is for performing game operations by the player. As illustrated in FIG. 1 to FIG. 3, the operation unit 90 in one or more embodiments has at least a joystick 91 and an operation button 92.

The joystick 91 is an operating lever that is used by the player to move the prize-acquisition unit 20 in the horizontal direction. The operation button 92 is an operation button used by the player to set the position of the prize-acquisition unit 20 in the horizontal direction. When the operation button 92 is pressed by the player, the prize-acquisition unit 20 starts to descend at the set position.

The play fee detection unit 93 is for detecting payment of a play fee by a player. The play fee detection unit 93 in one or more embodiments has a coin slot 94, a coin detection sensor (not shown), a coin passage path (not shown), and a coin box (not shown).

In one or more embodiments, the prize-acquisition game is started when a player inserts a predetermined number of coins into the coin slot 94. A coin inserted through the coin slot 94 is detected by a coin detection sensor.

The coin detection sensor is, for example, an optical sensor, and detects the presence or absence of a coin inserted through the coin slot 94 by a light-emitting unit and a light-receiving unit provided on the coin passage path. Coins that have passed through the coin passage path in this manner are stored in the coin box.

The prize outlet 96 is provided on the front surface of the base portion 80 and is for taking out a prize that has fallen when the prize acquired by the prize-acquisition unit 20 falls through the drop port area 72 in the exhibit unit 60.

The setting unit 100 is used when a player performs game operations or the like, or when a service provider performs setting operations. As illustrated in FIG. 1 to FIG. 3, the setting unit 100 in one or more embodiments has a setting operation unit 101 and a display unit (or display) 102.

The setting operation unit 101 is for receiving an operation input. The setting operation unit 101 in one or more embodiments is configured by a touch panel, and receives input instructions from the operator from the pressing position thereof.

The touch panel is layered on top of the display unit 102, and when a touch operation is performed on the screen, the pressed position (contact position) can be detected based on the change in electrostatic capacitance between the fingertip and the conductive film.

The display unit 102 displays various screens such as a game screen and a setting screen. The display unit 102 in one or more embodiments is configured with a liquid crystal display.

The control unit 110 is provided inside the base portion 80 and is a control unit for carrying out various controls of the prize-acquisition game device 1. The control unit 110 in one or more embodiments comprises a CPU (Central Processing Unit) executing a program stored in a memory.

The CPU is an arithmetic processing device for controlling the entire game device. The memory is used to secure an area for storing programs for the CPU, a working area, and the like, and includes a storage element such as a RAM (Random Access Memory).

As illustrated in FIG. 3, the control unit 110 in one or more embodiments has a determination unit 110a and a display control unit 110b. The determination unit 110a performs various controls related to the determination of the setting content of the prize-acquisition game. The display control unit 110b controls the display unit of the display unit 102.

The storage unit 120 is a storage unit that stores programs and data in order for the control unit 110 to execute the overall control of the prize-acquisition game device. In one or more embodiments, a memory element such as a ROM (Read Only Memory) is provided.

In one or more embodiments, the storage unit 120 stores setting information for the prize-acquisition game in addition to the game program and setting program. The setting information of the prize-acquisition game is, for example, information indicating the setting content related to the light-emitting unit 75.

### Configuration of moving unit 50

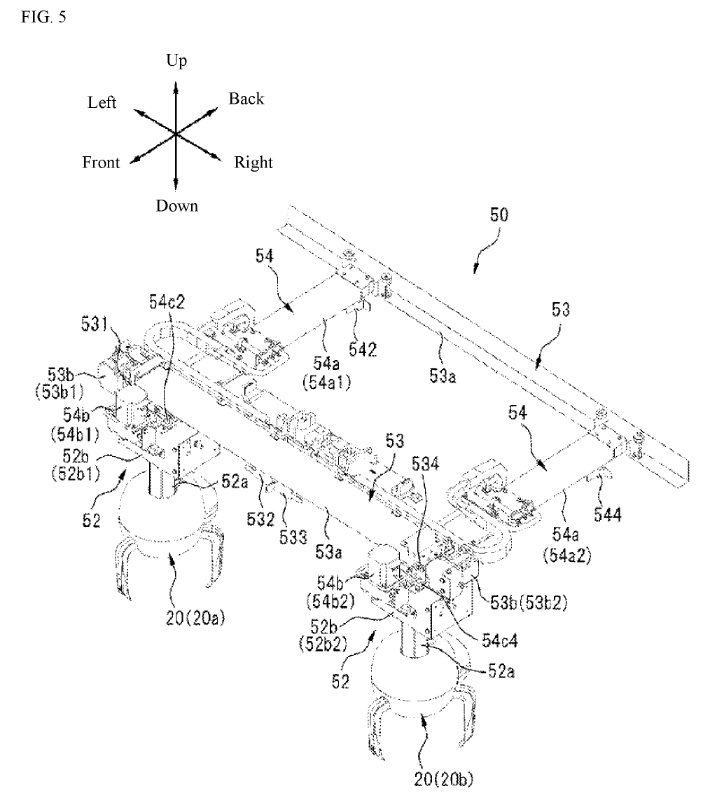

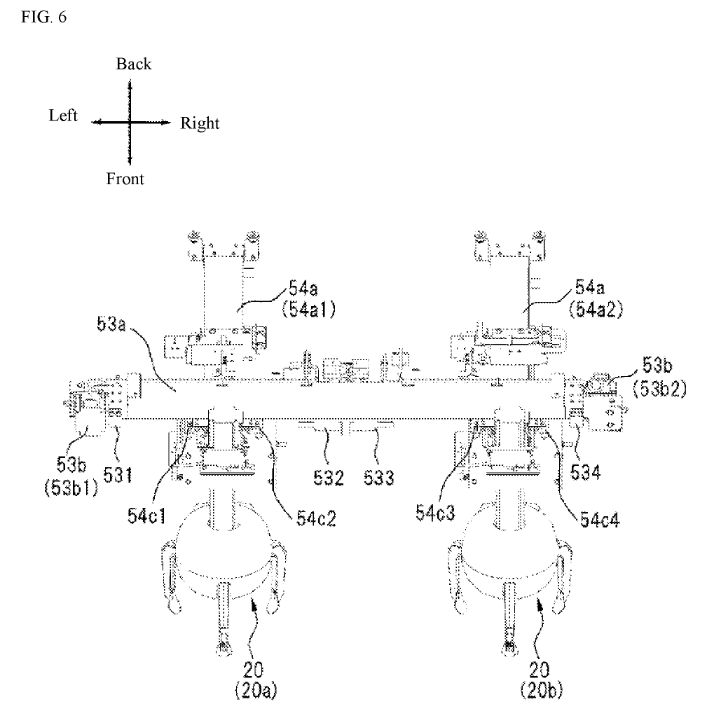

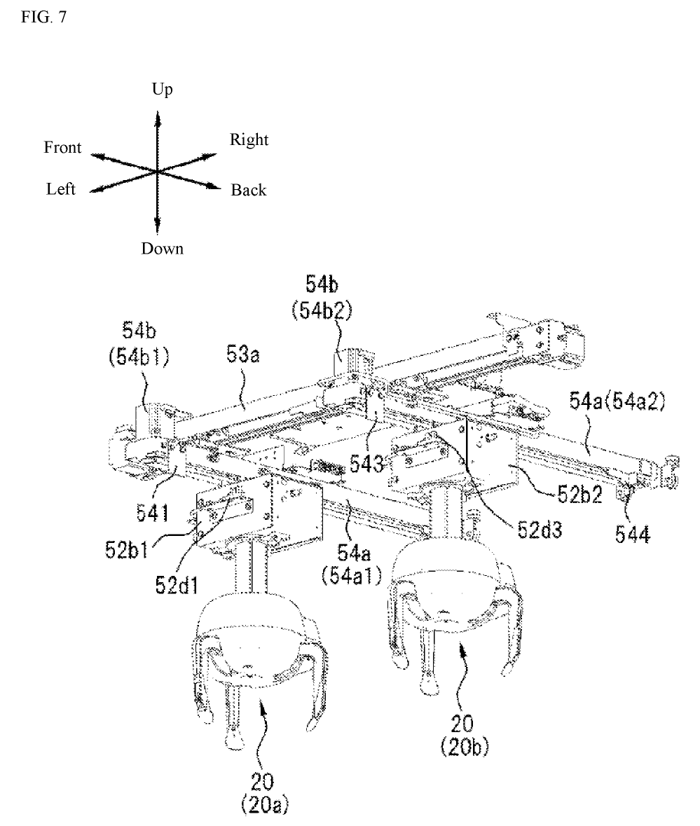

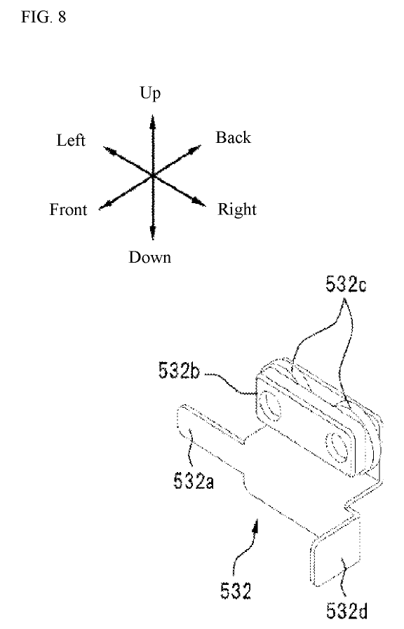

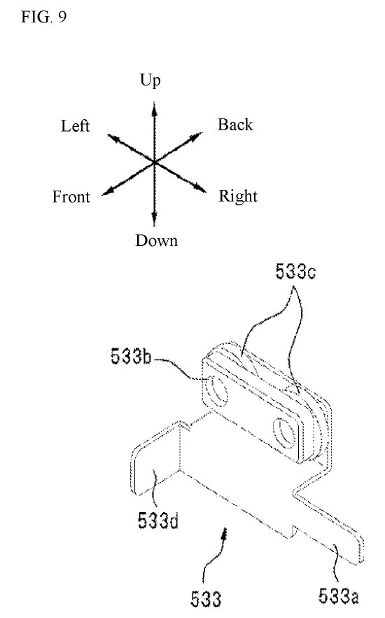

Configuration examples of the moving unit 50 according to one or more embodiments will be described with reference to FIG. 5 to FIG. 9. FIG. 5 is a schematic perspective view illustrating a configuration of a moving unit 50 according to one or more embodiments. FIG. 6 is a top-surface side perspective view illustrating a configuration of a moving unit 50 according to one or more embodiments. FIG. 7 is a right-surface side perspective view illustrating a configuration of a moving unit 50 according to one or more embodiments. FIG. 8 is a schematic perspective view illustrating a configuration of a first right end actuator 532 according to one or more embodiments. FIG. 9 is a schematic perspective view illustrating a configuration of a second left end actuator 533 according to one or more embodiments.

Hereinafter, the configurations of the horizontal moving unit 51 and the vertical moving unit 52 of the moving unit 50 according to one or more embodiments will be specifically described.

As illustrated in FIG. 5, the horizontal moving unit 51 has a left-right moving unit 53 and a front-back moving unit 54. The left-right moving unit 53 moves the prize-acquisition unit 20 in the left-right direction on the play area. The front-back moving unit 54 moves the prize-acquisition unit 20 in the front-back direction on the play area.

As illustrated in FIG. 5, the left-right moving unit 53 in one or more embodiments has a pair of fixed rails 53a extending in the left-right direction within the housing space, and a left-right moving motor 53b that is disposed on both the left and right ends of the fixed rails 53a on the front side.

As illustrated in FIG. 5, the front-back moving unit 54 in one or more embodiments has a plurality of moving rails 54a extending in the front-back direction within the housing space, and a front-back moving motor 54b arranged at the front end of each moving rail 54a.

As illustrated in FIG. 5, the vertical moving unit 52 has a lifting unit 52a configured to be extendable and retractable along the up-down direction, and a suspending unit (or suspender) 52b that suspends the lifting unit 52a so that it can be raised and lowered. The lifting unit 52a is configured by fitting a plurality of pipes of successively smaller diameters in a telescopic manner so as to be freely slidable. The prize-acquisition unit 20 is attached to the lower end of the lifting unit 52a in a state in which it is connected to a wire that passes through the inside of the pipe. The lifting unit 52a is attached to the lower end of the suspending unit 52b with the prize-acquisition unit 20 suspended therefrom. The upper end of the suspending unit 52b is supported so as to be freely movable along the front-back direction by the moving rail 54a.

The vertical moving unit 52 according to one or more embodiments, in an inner portion of the suspending unit 52b, has a wire winding unit (or wire winder), an up-down moving motor , an upper limit sensor, and a lower limit sensor. The wire winding unit is driven by the up-down moving motor to wind up the wire, thereby raising the prize-acquisition unit 20 while sequentially storing the lower pipes in the upper pipe, or to unwind the wire, thereby lowering the prize-acquisition unit 20 while sequentially sending out the lower pipes from the upper pipe. The upper limit sensor detects whether or not the rising of the prize-acquisition unit 20 has stopped by winding up the wire connected to the prize-acquisition unit 20. The lower limit sensor detects whether the lowering of the prize-acquisition unit 20 has stopped based on the change in the tension of the wire connected to the prize-acquisition unit 20.

The fixed rail 53a according to one or more embodiments extends in the left-right direction across the first play area on the left side and the second play area on the right side which are adjacent to each other on the left and right within the housing space, and as illustrated in FIG. 5, supports a first moving rail 54a1 corresponding to the first play area on the left side and a second moving rail 54a2 corresponding to the second play area on the right side so as to be freely movable along a shared rail.

As illustrated in FIG. 5, a first left-right moving motor 53b1 for moving the first moving rail 54a1 in the left-right direction is disposed on the left end of the front fixed rail 53a. Furthermore, a second left-right moving motor 53b2 for moving the second moving rail 54a2 in the left-right direction is disposed at the right end of the fixed rail 53a on the front side.

The front fixed rail 53a is formed to have a U-shaped cross section, and inside it are disposed a first driving pulley that is rotated by the first left-right moving motor 53b1, a first driven pulley attached to the right end of the front fixed rail 53a, and a first left-right belt that is hung between the first driving pulley and the first driven pulley.

Furthermore, inside the front fixed rail 53a, a second driving pulley rotationally driven by the second left-right moving motor 53b2, a second driven pulley attached to a left end of the front fixed rail 53a, and a second left-right belt hanging between the second main drive pulley and the second driven pulley are disposed.

The first left-right belt and the second left-right belt are disposed so as to be parallel to each other inside the front fixed rail 53a, and the first moving rail 54a1 is connected to the first left-right belt via a first linking portion, and the second moving rail 54a2 is connected to the second left-right belt via a second linking portion.

Therefore, by rotating the first left-right moving motor 53b1 forward or backward, the first moving rail 54a1 linked to the first left-right belt can move back and forth in the left-right direction along the fixed rail 53a. In the same manner, by rotating the second left-right moving motor 53b2 forward or backward, the second moving rail 54a2 connected to the second left-right belt can move back and forth in the horizontal direction along the fixed rail 53a.

In one or more embodiments, the first moving rail 54a1 supports a first suspending unit (or first suspender) 52b1, from which is suspended a first prize-acquisition unit 20a corresponding to the first play area on the left side, so as to be freely movable in the front-back direction, as illustrated in FIG. 5 and FIG. 7. That is, the first prize-acquisition unit 20a is supported by the first moving rail 54a1 so as to be freely movable along the front-back direction.

Similarly, a second suspending unit (or second suspender) 52b2 from which a second prize-acquisition unit 20b corresponding to the second play area on the right side is suspended is supported on the second moving rail 54a2 so as to be freely movable in the front-back direction. That is, the second prize-acquisition unit 20b is supported by the second moving rail 54a2 so as to be freely movable along the front-back direction.

In addition, as illustrated in FIG. 5 and FIG. 7, a first front-back moving motor 54b1 is disposed at the front end of the first moving rail 54a1 for moving, in the front-back direction, the first suspending unit 52b1 from which the first prize-acquisition unit 20a is suspended.

Similarly, a second front-back moving motor 54b2 is disposed at the front end of the second moving rail 54a2 for moving, in the front-back direction, the second suspending unit 52b2 having the second prize-acquisition unit 20b suspended.

The first moving rail 54a1 is formed to have a U-shaped cross section, and the driving pulley rotationally driven by the first front-back moving motor 54b1, a driven pulley attached to a back end of the first moving rail 54a1, and the front-back belt hung between the driving pulley and the driven pulley are disposed inside of the first moving rail 54a1. The first suspending unit 54b1is connected to the front-back belt via a linking portion.

Therefore, by rotating the first front-back moving motor 54b1 forward or backward, the first prize-acquisition unit 20a, together with the first suspending unit 52b1 connected to the front-back belt, can move back and forth in the front-back direction along the first moving rail 54a1.

Similarly, the driving pulley rotationally driven by the second front-back moving motor 54b2, the driven pulley disposed at a rear end of the second moving rail 54a2, and the front-back belt hung between the driving pulley and the driven pulley are disposed inside the second moving rail 54a2. The second suspending unit 52b2 is connected to the front-back belts via a linking portion.

Therefore, by rotating the second front-back moving motor 54b2 forward or backward, the second prize-acquisition unit 20b together with the second suspending unit 54b2 connected to the front-back belt can reciprocate in the front-back direction along the second moving rail 54a2.

As illustrated in FIG. 6, a first left end sensor 54c1 that detects the left end position of the first play area is attached to the front left side of the first moving rail 54a1. Then, as illustrated in FIG. 6, a first left end actuator 531 for actuating the first left end sensor 54c1 is attached to the left end of the front fixed rail 53a.

As a result, when the first left end actuator 531 actuates the first left end sensor 54c1 due to leftward movement of the first moving rail 54a1, the first prize-acquisition unit 20a together with the first moving rail 54a1 are restricted from moving to the left in the left-right direction in the first play area.

As illustrated in FIG. 6, a first right end sensor 54c2 for detecting a right end position of a first play area is attached to the right front side of the first moving rail 54a1. As illustrated in FIG. 6, the first right end actuator 532 for actuating the first right end sensor 54c2 is supported in the center of the fixed rail 53a on the front side.

As a result, when the first right end actuator 532 actuates the first right end sensor 54c2 due to rightward movement of the first moving rail 54a1, movement of the first prize-acquisition unit 20a in the left-right direction in the first play area together with the first moving rail 54a1 is restricted.

As illustrated in FIG. 6, a second left end sensor 54c3 that detects the left end position of the second play area is attached to the front left side of the second moving rail 54a2. As illustrated in FIG. 6, the second left end actuator 533 for actuating the second left end sensor 54c3 is supported in the center of the fixed rail 53a on the front side.

As a result, when the second left end actuator 533 actuates the second left end sensor 54c3 due to leftward movement of the second moving rail 54a2, the second prize-acquisition unit 20b together with the second moving rail 54a2are restricted from moving to the left in the left-right direction in the second play area.

As illustrated in FIG. 6, a second right end sensor 54c4 for detecting a right end position of a second play area is attached to the right front side of the second moving rail 54a2. Then, as illustrated in FIG. 6, a second right end actuator 534 for actuating the second right end sensor 54c4 is attached to the right end of the front fixed rail 53a.

As a result, when the second right end actuator 534 actuates the second right end sensor 54c4 due to rightward movement of the second moving rail 54a2, movement of the second prize-acquisition unit 20b in the left-right direction in the second play area together with the second moving rail 54a2 is restricted.

The first left end sensor 54c1, the first right end sensor 54c2, the second left end sensor 54c3, and the second right end sensor 54c4 are optical sensors that detect the presence or absence of a shielding object based on whether or not the light irradiated from a light-emitting unit (or light emitter) is received by a light receiving unit (or light receiver). That is, each sensor can detect this when the actuator comes between the light-emitting unit and the light receiving unit.

The first left end actuator 531 and the second right end actuator 534 are fixed to the front fixed rail 53a so that their mounting positions cannot be changed in principle. In contrast, the first right end actuator 532 and the second left end actuator 533, are supported by the fixed rail 53a on the front side so as to be movable in the left-right direction, and the mounting position can be changed (that is, the right end position of the first play area and the left end position of the second play area can each be changed.)

The first right end actuator 532 is an example of a first actuator, and is a member that is slidable relative to the front fixed rail 53a. As illustrated in FIG. 8, the first right end actuator 532 of one or more embodiments has a shielding portion (or shield) 532a that protrudes to the left in the left-right direction and blocks light emitted from the first right end sensor 54c2 (first sensor), a magnet 532b, two wheels 532c, and a knob portion 532d that protrudes to the front in the front-back direction.

In one or more embodiments, a concave groove extending in the left-right direction is formed on the inner side surface of the front fixed rail 53a. The front fixed rail 53a supports the first right end actuator 532 so that the wheels can be placed in the grooves to guide the first right end actuator 532. A service provider (for example, a store clerk or the like) can operate the knob portion 532d to slide the first right end actuator 532 left and right along the front fixed rail 53a, thereby changing the position of the first right end actuator 532 and adjusting the right end position of the first play area. The first right end actuator 532 can be fixed at a position after being slid by the magnet 532b (after the first right end actuator 532 is slidably moved, the position can be maintained).

The second left end actuator 533 is an example of a second actuator, and is a member that is slidable relative to the front fixed rail 53a. As illustrated in FIG. 9, the second left end actuator 533 of one or more embodiments has a shielding portion (or shield) 533a that protrudes to the right in the left-right direction and blocks light emitted from the second left end sensor 54c3 (second sensor), a magnet 533b, two wheels 533c, and a knob portion 533d that protrudes to the front in the front-back direction.

In one or more embodiments, similarly to the first right end actuator 532 described above, the second left end actuator 533 is guided by placing its wheels in the grooves of the front fixed rail 53a. The service provider can adjust the left end position of the second play area by sliding the second left end actuator 533 in the horizontal direction along the front fixed rail 53a and changing the position of the second left end actuator 533 by operating the knob portion 533d independently of the knob portion 532d of the first right end actuator 532. The second left end actuator 533 can be fixed at a position after being slid by the magnet 533b (after the second left end actuator 533 is slidably moved, the position can be maintained).

In this way, the front fixed rail 53a supports the first right end actuator 532 at a position after sliding movement between the first moving rail 54a1 and the second left end actuator 533, thereby making it possible to change the right end position of the first play area, and supports the second left end actuator 533 at a position after sliding movement between the first right end actuator 532 and the second moving rail 54a2, thereby making it possible to change the left end position of the second play area.

As illustrated in FIG. 7, a first front end sensor 52d1 that detects the front end position of the first play area is attached to the front end of the first suspending unit 52b1. Then, as illustrated in FIG. 7, a first front end actuator 541 for actuating the first front end sensor 52d1 is attached to the front end of the first moving rail 54a1.

As a result, when the first front end actuator 541 actuates the first front end sensor 52d1 due to forward movement of the first suspending unit 52b1, the movement of the first prize-acquisition unit 20a together with the first suspending unit 52b1 to the front side in the front-back direction in the first play area is restricted.

As illustrated in FIG. 7, a second front end sensor 52d3 that detects the front end position of the second play area is attached to the front end of the second suspending unit54b2. Then, as illustrated in FIG. 7, a second front end actuator 543 for actuating the second front end sensor 52d3 is attached to the front end of the second moving rail 54a2.

As a result, when the second front end actuator 543 actuates the second front end sensor 52d3 due to forward movement of the second suspending unit 52b2, the second prize-acquisition unit 20b together with the second suspending unit 52b2 are restricted in their forward movement in the front-back direction in the second play area.

A first back end sensor (not shown) for detecting a back end position of the first play area is attached to the back end of the first suspending unit 52b1. Then, as illustrated in FIG. 5, a first back end actuator 542 for actuating the first back end sensor is attached to the back end of the first moving rail 54a1.

As a result, when the first back end actuator 542 actuates the first back end sensor due to backward movement of the first suspending unit 52b1, the backward movement of the first prize-acquisition unit 20a together with the first suspending unit 52b1 in their front-back movement in the first play area is restricted.

A second back end sensor (not shown) for detecting a back end position of the second play area is attached to the back end of the second suspending unit 52b2. Then, as illustrated in FIG. 5 and FIG. 7, a second back end actuator 544 for actuating the second back end sensor is attached to the back end of the second moving rail 54a2.

As a result, when the second back end actuator 544 actuates the second back end sensor due to backward movement of the second suspending unit 52b2, the second prize-acquisition unit 20b together with the second suspending unit 52b2 are restricted in their front-back movement in the second play area.

The first front end sensor 52d1, the first back end sensor, the second front end sensor 52d3, and the second back end sensor are optical sensors that detect the presence or absence of a shielding object based on whether or not the light irradiated from the light-emitting unit is received by the light receiving unit. That is, each sensor can detect this when the actuator comes between the light-emitting unit and the light receiving unit.

The first front end actuator 541 and the first back end actuator 542 are fixed to the first moving rail 54a1 so that their mounting positions cannot be changed in principle. Similarly, the second front end actuator 543 and the second back end actuator 544 are fixed to the second moving rail 54a2 so that their mounting positions cannot be changed in principle.

### Operation of prize-acquisition game device 1

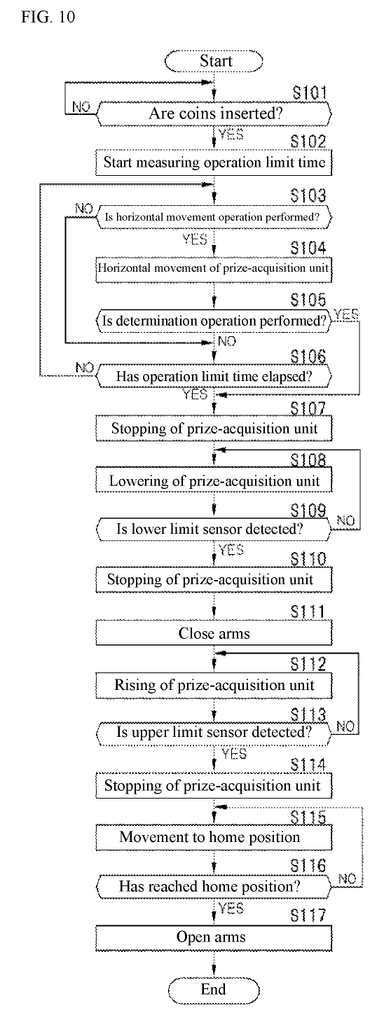

The operation of the prize-acquisition game device 1 according to one or more embodiments will be described with reference to FIG. 10. FIG. 10 is a flowchart explaining operation examples of the prize-acquisition game device 1 according to one or more embodiments. Hereinafter, an example of operation in the first play area will be specifically explained, and an explanation of the second play area will be omitted as it is similar to the first play area.

When the play fee detection unit 93 detects the insertion of a coin (step S101: YES), the control unit 110 starts measuring a preset operation restriction time (step S102).

Next, when the control unit 110 receives an operation signal for horizontally moving the first prize-acquisition unit 20a by the player operating the joystick 91 (step S103: YES), it drives the horizontal moving unit 51 in accordance with the player's operation to move the first prize-acquisition unit 20a horizontally in the first play area (step S104).

In one or more embodiments, when the first prize-acquisition unit 20a is moving horizontally in the first play area, if the first right end actuator 532 actuates the first right end sensor 54c2 due to rightward movement of the first moving rail 54a1, the control unit 110 stops the first prize-acquisition unit 20a at the right end position of the first play area. In addition, when the first back end actuator 542 actuates the first back end sensor due to the backward movement of the first suspending unit 52b1, the first prize-acquisition unit 20a is stopped at the back end position of the first play area. In addition, when the first left end actuator 531 actuates the first left end sensor 54c1 due to the leftward movement of the first moving rail 54a1, the first prize-acquisition unit 20a is stopped at the left end position of the first play area. In addition, when the first front end actuator 541 actuates the first front end sensor 52d1 by moving the first suspending unit 52b1 in the forward direction, the first prize-acquisition unit 20a is stopped at the front end position of the first play area.

On the other hand, if the player does not operate the joystick 91 (step S102: NO), the control unit 110 determines whether or not the operation restriction time has elapsed (step S106). Then, in a case where the operation restriction time has not elapsed (step S106: NO), the process returns to step S103. Operation Restrictions In a case where the time has elapsed (step S106: YES), the first prize-acquisition unit 20a is stopped (step S107).

Next, when the control unit 110 receives an operation signal for determining the position of the first prize-acquisition unit 20a after horizontal movement by the player operating the operation button 92 (step S105: YES), it stops the first prize-acquisition unit 20a at the position after the horizontal movement (step S107).

On the other hand, if the player does not operate the operation button 92 (step S103: NO), the control unit 110 determines whether or not the operation restriction time has elapsed (step S106). Then, in a case where the operation restriction time has not elapsed (step S106: NO), the process returns to step S103. In a case where the operation restriction time has elapsed (step S106: YES), the first prize-acquisition unit 20a is stopped (step S107).

Next, when the first prize-acquisition unit 20a stops (step S107), the control unit 110 drives the vertical moving unit 52 to lower the first prize-acquisition unit 20a to the stopping position in the first play area (step S108).

When the lower limit sensor detects that the descent of the first prize-acquisition unit 20a has stopped (step S109: YES), the control unit 110 stops the first prize-acquisition unit 20a (step S110).

Next, when the first prize-acquisition unit 20a is in a stopped state (step S110), the control unit 110 causes the drive unit 35 to rotate the arm portion 25 in a closing direction (step S111).

Next, when the arm portion 25 of the first prize-acquisition unit 20a is in a closed state (step S111), the control unit 110 drives the vertical moving unit 52 to raise the first prize-acquisition unit 20a (step S112).

When it is detected that the first prize-acquisition unit 20a has stopped rising by the upper limit sensor (step S113: YES), the control unit 110 stops the first prize-acquisition unit 20a (step S114).

Next, the control unit 110 drives the horizontal moving unit 51 to move the first prize-acquisition unit 20a toward the home position (step S115), and determines whether or not the home position has been reached (step S116).

In one or more embodiments, the control unit 110 determines that the first prize-acquisition unit 20a has reached the home position when the first left end actuator 531 actuates the first left end sensor 54c1 due to the leftward movement of the first moving rail 54a1, and the first front end actuator 541 actuates the first front end sensor 52d1 due to forward movement of the first suspending unit 52b1.

Next, when the first prize-acquisition unit 20a is located at the home position (step S116: YES), the control unit 110 causes the drive unit 35 to rotate the arm portion 25 in the opening direction (step S117).

As described above, according to the prize-acquisition game device 1 according to the embodiment, the service provider can individually change the size of the first play area and the second play area by adjusting the positions of the first right end actuator 532 (first actuator) and the second left end actuator 533 (second actuator) in the horizontal direction along the fixed rail 53a. Then, in each of the first play area and the second play area whose size has been changed, it is possible to limit the range of movement within the housing space of each of the first prize-acquisition unit 20a and the second prize-acquisition unit 20b.

### Regarding light-emitting area settings

Light-emitting area settings according to one or more embodiments will be described. Hereinafter, first, a case where a light-emitting area is set using the setting unit 100 will be described. Next, a case where the light-emitting area is set using the first right end actuator 532 and the second left end actuator 533 will be described. Finally, a case where the light-emitting area is set using the partition plate 65 will be described.

### Specific Example 1

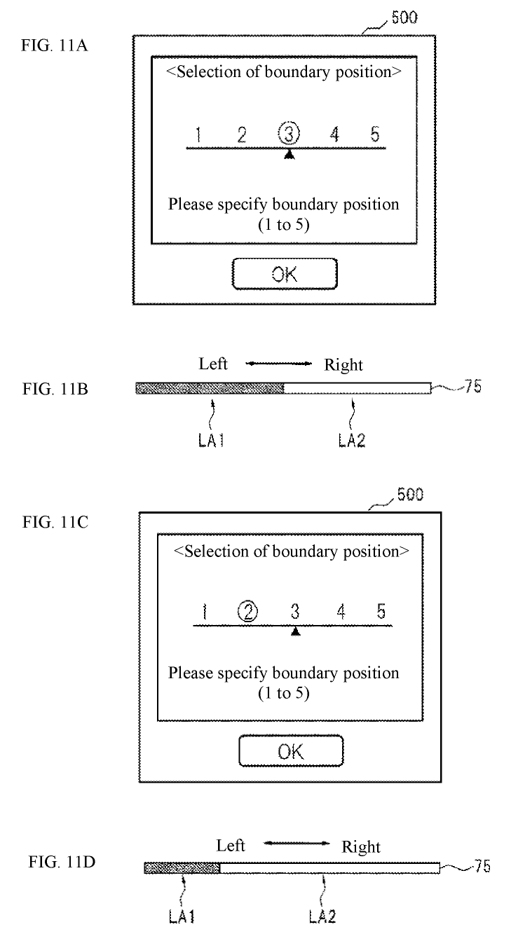

The light-emitting area settings according to one or more embodiments will be described with reference to FIGS. 11A-11D. FIGS. 11A-11D are views each illustrating a case where the light-emitting area is set using the setting unit 100. FIG. 11A is an image view illustrating a setting screen 500 in a state in which a boundary position is selected in a case where the first play area and the second play area are set to have the same size. FIG. 11B is a schematic front view illustrating the light-emitting unit 75 in a state in which a first light-emitting area LA1 and a second light-emitting area LA2 have the same size. FIG. 11C is an image view illustrating a setting screen 500 in a state in which a boundary position is selected in a case where the second play area is set to be larger than the first play area. FIG. 11D is a schematic front view illustrating the light-emitting unit 75 in a state in which the second light-emitting area LA2 is set to be larger than the first light-emitting area LA1.

The display control unit 110b causes the display unit 102 to display a setting screen 500 for determining setting contents related to the light-emitting unit 75 when the service provider performs a predetermined touch operation using the setting operation unit 101.

In the setting screen 500 in one or more embodiments, the boundary position of the light-emitting unit 75 can be selected from five positions. In addition, the boundary position of the light-emitting unit 75 is set in advance in association with each of the five selectable boundary positions. The boundary position of the light-emitting unit 75 corresponds to the boundary position between the first play area and the second play area. It is noted that the number of selectable boundary positions is not limited to five, but may be four or less, or six or more.

FIG. 11A illustrates a case where the center "3" is selected by a touch operation by the service provider. The selection of "3" corresponds to a case where a boundary position is designated when the first play area on the left side and the second play area on the right side are set to have the same size.

Based on the service provider's selection of "3" on the setting screen 500 illustrated in FIG. 11A, the determination unit 110a determines (or sets) the boundary position of the light-emitting unit 75 to be the selected boundary position that has been associated with "3". That is, the determined boundary position is a boundary position when the first play area on the left side and the second play area on the right side are set to have the same size.

When the boundary position is set in this way, the light-emitting unit 75 changes the size of the first light-emitting area LA1 corresponding to the first play area on the left side and the second light-emitting area LA2 corresponding to the second play area on the right side so that they have the same size, as illustrated in FIG. 11B.

FIG. 11C illustrates a case where the central left "2" is selected by a touch operation by the service provider. The selection of "2" corresponds to a case where a boundary position is designated when the second play area on the right side is set to be larger than the first play area on the left side.

Based on the service provider's selection of "2" on the setting screen 500 illustrated in FIG. 11C, the determination unit 110a determines (or sets) the boundary position of the light-emitting unit 75 to be the selected boundary position that has been associated with "2". That is, the determined boundary position is a boundary position when the second play area on the right side is set to be larger than the first play area on the left side.

When the boundary position is set in this way, the light-emitting unit 75 changes the size of the first light-emitting area LA1 corresponding to the first play area on the left side and the second light-emitting area LA2 corresponding to the second play area on the right side so that the second light-emitting area LA2 is larger than the first light-emitting area LA1, as illustrated in FIG. 11D.

The light-emitting unit 75 in one or more embodiments can make the light emission color of the first light-emitting area LA1 corresponding to the first play area on the left side different from the light emission color of the second light-emitting area LA2 corresponding to the second play area on the right side.

For example, the light emission color of the first light-emitting area LA1 corresponding to the first play area is designated as "red", while the light emission color of the second light-emitting area LA2 corresponding to the second play area on the right side is designated as "blue", thereby making them distinguishable from each other.

In addition, the light-emitting unit 75 in one or more embodiments can make the light emission pattern of the first light-emitting area LA1 corresponding to the first play area on the right side different from the light emission pattern of the second light-emitting area LA2 corresponding to the second play area on the right side.

For example, the light emission pattern of the first light-emitting area LA1 corresponding to the first play area on the left side is set to "continuously lit", while the light emission pattern of the second light-emitting area LA2 corresponding to the second play area on the right side is set to "flashing ", thereby making them distinguishable from each other.

As described above, by making the light emission colors or light emission patterns of the first light-emitting area LA1 and the second light-emitting area LA2, the size of each of the first play area on the left and the second play area on the right can be easily ascertained.

### Specific Example 2

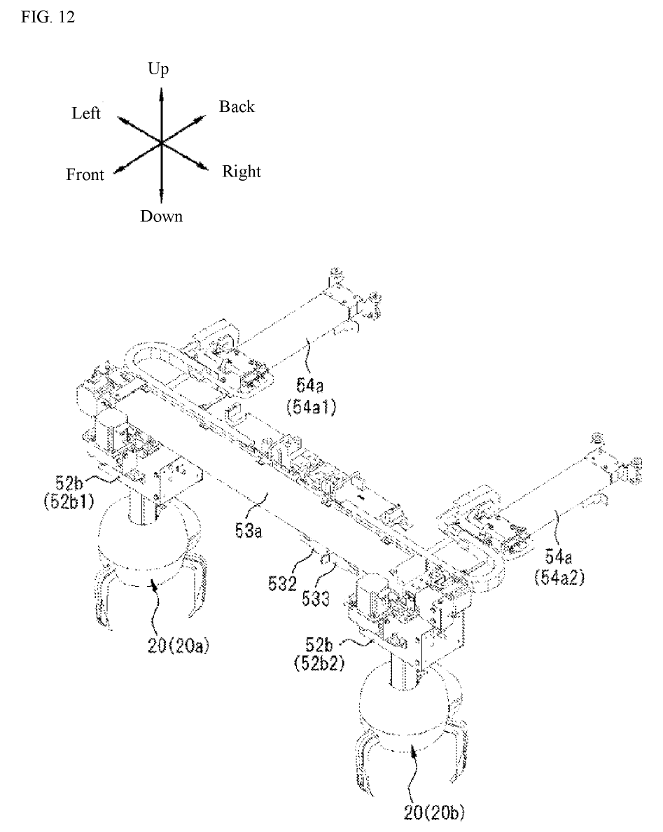

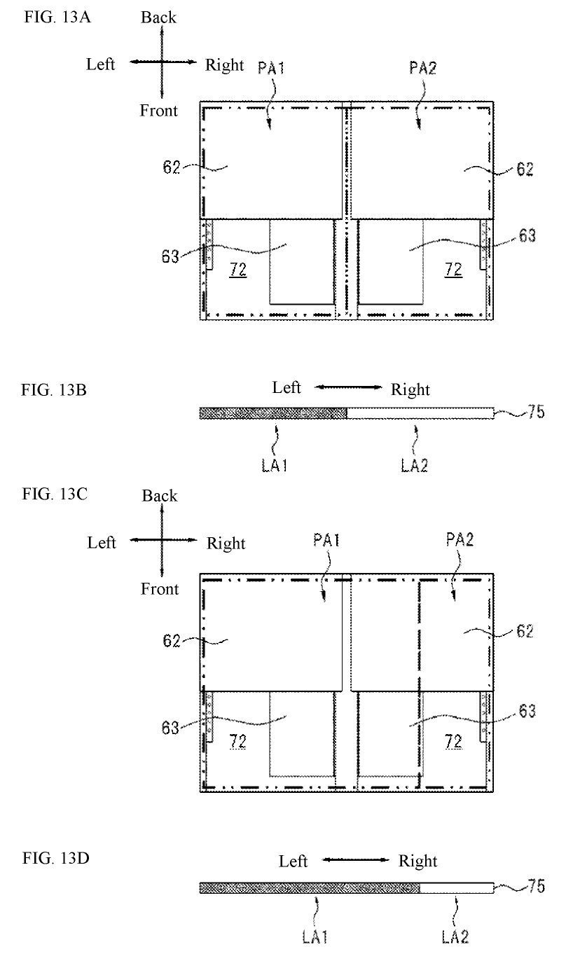

Play area settings according to one or more embodiments will be described with reference to FIG. 5, FIG. 12, and FIGS. 13A-13D. FIG. 12 is a schematic external view illustrating a disposition state of a first right end actuator 532 and a second left end actuator 533 in a case where the second play area is set to be smaller than the first play area. FIGS. 13A-13D are views each illustrating a case where a light-emitting area is set using the first right end actuator 532 and the second left end actuator 533. FIG. 13A is a schematic plan view illustrating the inside of the casing in a case where the first play area PA1 and the second play area PA2 are set to the same size. FIG. 13B is a schematic front view illustrating the light-emitting unit 75 in a state in which the first light-emitting area LA1 and the second light-emitting area LA2 have the same size. FIG. 13C is a schematic plan view illustrating the inside of the casing in a case where the second play area PA2 is set to be smaller than the first play area PA1. FIG. 13D is a schematic front view illustrating the light-emitting unit 75 in a state in which the second light-emitting area LA2 is set to be smaller than the first light-emitting area LA1.

In the prize-acquisition game device 1 according to one or more embodiments, the first right end actuator 532 and the second left end actuator 533 can also be attached to the fixed rail 53a by screwing or the like. The attachment positions of the first right end actuator 532 and the second left end actuator 533 can be selected from five positions on the fixed rail 53a. In addition, the boundary position of the light-emitting unit 75 is set in advance in association with each of the five selectable boundary positions. It is noted that the number of selectable attachment positions is not limited to five, but may be four or less, or six or more.

As illustrated in FIG. 5, when each of the first right end actuator 532 and the second left end actuator 533 is attached to the center of the left-right direction of the fixed rail 53a by the work of the service provider, the right end position of the first play area and the left end position of the second play area are set to the center of the left-right direction of the fixed rail 53a. In this case, as illustrated in FIG. 13A, the first play area PA1 and the second play area PA2 have the same size. Therefore, the movable ranges of the first prize-acquisition unit 20a and the second prize-acquisition unit 20b within the housing space are also the same size.

The prize-acquisition game device 1 according to one or more embodiments can also be configured to have a position detector that detects the right end position of the first play area and the left end position of the second play area by detecting the attachment positions of the first right end actuator 532 and the second left end actuator 533 on the fixed rail 53a in the left-right direction.

For example, the position detector may use an optical sensor as an example. The optical sensor detects the presence or absence of the attachment of the first right end actuator 532 and the second left end actuator 533 by using a light-emitting unit and a light-receiving unit, which are provided on the fixed rail 53a.

In one or more embodiments, in a case where the disposition of the first right end actuator 532 and the second left end actuator 533 is as illustrated in FIG. 5, it is assumed that the position detector detects the central attachment position of the central "3" out of the five positions. The attachment position of "3" corresponds to the detection position of the right end position of the first play area and the left end position of the second play area in a case where the first play area on the left side and the second play area on the right side are set to have the same size.

In the disposition state illustrated in FIG. 5, the determination unit 110a determines (or sets) the boundary position of the light-emitting unit 75 to be the boundary position associated with the detected "3" based on the detection positions of the right end position of the first play area and the left end position of the second play area. That is, the determined boundary position is a boundary position when the first play area PA1 and the second play area PA2 are set to have the same size.

When the boundary position is set in this way, the light-emitting unit 75 changes the size of the first light-emitting area LA1 corresponding to the first play area and the second light-emitting area LA2 corresponding to the second play area so that they have the same size, as illustrated in FIG. 13B.

In addition, as illustrated in FIG. 12, in a case where each of the first right end actuator 532 and the second left end actuator 533 is attached to a position offset in the right direction from the center of the left-right direction of the fixed rail 53a by the work of the service provider, the right end position of the first play area and the left end position of the second play area are changed to be disposed shifted in the right direction from the center in the left-right direction of the fixed rail 53a. In this case, as illustrated in FIG. 13C, the second play area PA2 is smaller than the first play area PA1. Therefore, compared to the state illustrated in FIG. 5, the movable range of the first prize-acquisition unit 20a within the housing space is expanded, while the movable range of the second prize-acquisition unit 20b within the housing space is reduced.

In one or more embodiments, when the disposition of the first right end actuator 532 and the second left end actuator 533 is as illustrated in FIG. 12, it is assumed that the position detector detects the central right attachment position "4" out of the five positions. The attachment position of "4" corresponds to the detection position of the right end position of the first play area and the left end position of the second play area in a case where the second play area on the right side is set to be smaller than the first play area on the left side.

In the disposition state illustrated in FIG. 12, the determination unit 110a determines (or sets) the boundary position of the light-emitting unit 75 to be the boundary position associated with the detected "4" based on the detection positions of the right end position of the first play area and the left end position of the second play area. That is, the determined boundary position is a boundary position when the second play area PA2 is set to be smaller than the first play area PA1.

When the boundary position is set in this way, the light-emitting unit 75 changes the size of the first light-emitting area LA1 corresponding to the first play area and the second light-emitting area LA2 corresponding to the second play area so that the second light-emitting area LA2 is smaller than the first light-emitting area LA1, as illustrated in FIG. 13D.

The light-emitting unit 75 in one or more embodiments can make the light emission color of the first light-emitting area LA1 corresponding to the first play area different from the light emission color of the second light-emitting area LA2 corresponding to the second play area.

In addition, the light-emitting unit 75 in one or more embodiments can make the light emission pattern of the first light-emitting area LA1 corresponding to the first play area different from the light emission pattern of the second light-emitting area LA2 corresponding to the second play area.

As described above, by making the light emission colors or light emission patterns of the first light-emitting area LA1 and the second light-emitting area LA2 different from each other, the size of each of the first play area and the second play area can be easily ascertained.

It is noted that the prize-acquisition game device 1 according to one or more embodiments can also be configured to have a position detector that detects only the right end position of the first play area or only the left end position of the second play area by detecting the attachment positions of only the first right end actuator 532 or only the second left end actuator 533 on the fixed rail 53a in the left-right direction.

In this case, in the disposition state illustrated in FIG. 5, the determination unit 110a may determine the boundary position of the light-emitting unit 75 to be a boundary position a boundary position when the first play area PA1 and the second play area PA2 are set to have the same size, based on the detection position of the right end position of the first play area or the left end position of the second play area. In addition, in the disposition state illustrated in FIG. 12, the determination unit 110a may determine the boundary position of the light-emitting unit 75 to be a boundary position when the second play area PA2 is set to be smaller than the first play area PA1, based on the detection position of the right end position of the first play area or the left end position of the second play area.

### Specific Example 3

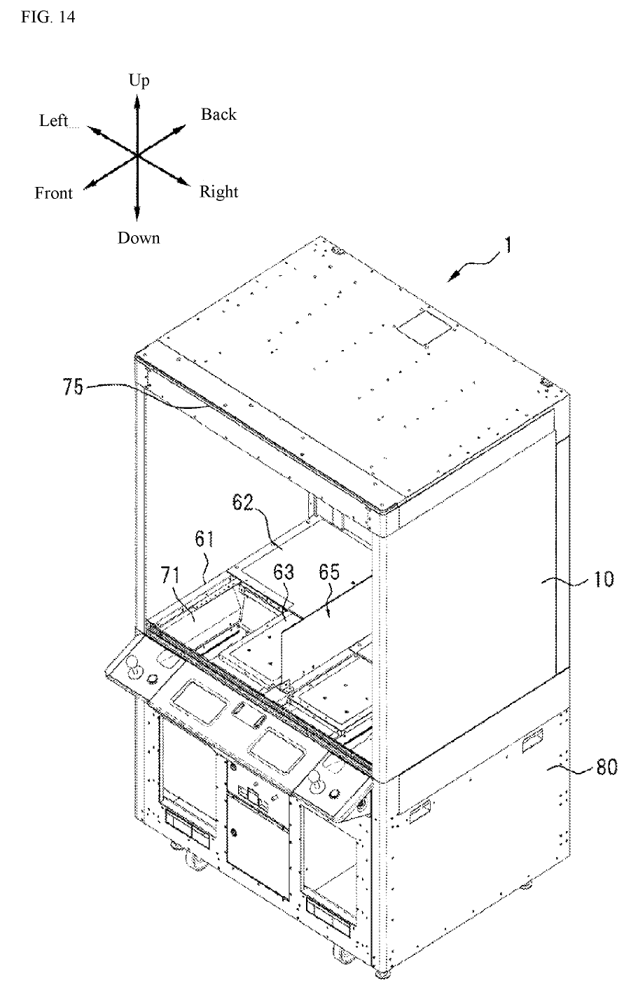

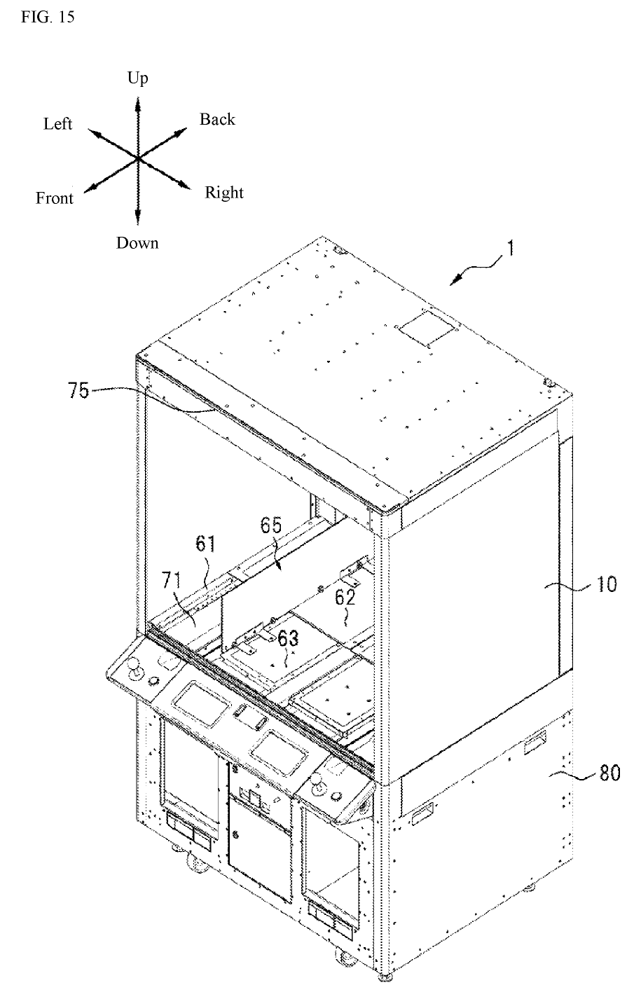

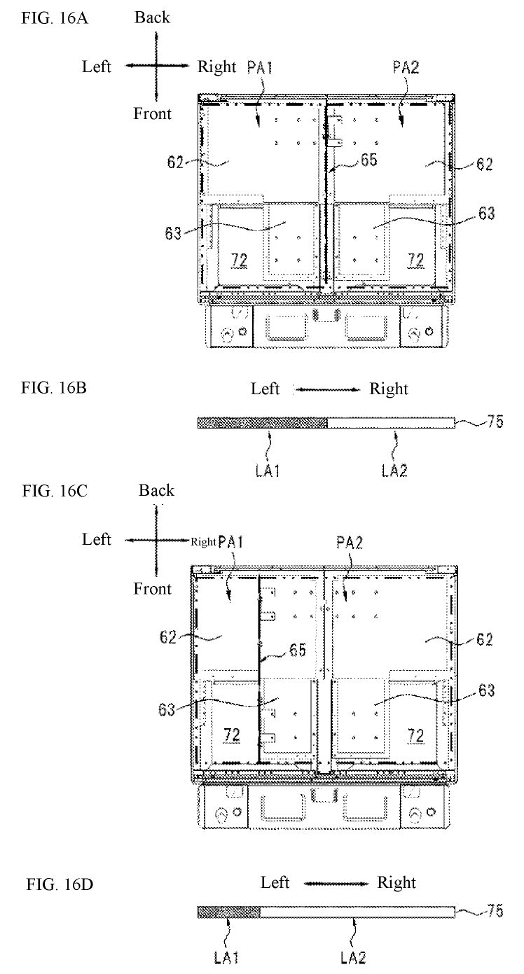

Play area settings according to one or more embodiments will be described with reference to FIG. 14 to FIGS. 16A-16D. FIG. 14 is a schematic external view illustrating the disposition state of the partition plate 65 in a case where a first play area and a second play area are set to the same size. FIG. 15 is a schematic external view illustrating the disposition state of the partition plate 65 in a case where the second play area is set to be larger than the first play area. FIGS. 16A-16D are views each illustrating a case where a light-emitting area is set using the partition plate 65. FIG. 16A is a schematic plan view illustrating the inside of the casing in a case where the first play area PA1 and the second play area PA2 are set to the same size. FIG. 16B is a schematic front view illustrating the light-emitting unit 75 in a state in which the first light-emitting area LA1 and the second light-emitting area LA2 have the same size. FIG. 16C is a schematic plan view illustrating the inside of the casing in a case where the second play area PA2 is set to be larger than the first play area PA1. FIG. 16D is a schematic front view illustrating the light-emitting unit 75 in a state in which the second light-emitting area LA2 is set to be larger than the first light-emitting area LA1.

In the prize-acquisition game device 1 according to one or more embodiments, the partition plate 65 for partitioning the first play area on the left side and the second play area on the right side can be attached in the inside of the casing by screwing or the like. The attachment positions of the partition plate 65 can be selected from five positions within the casing. In addition, the boundary position of the light-emitting unit 75 is set in advance in association with each of the five selectable boundary positions. It is noted that the number of selectable attachment positions is not limited to five, but may be four or less, or six or more.

As illustrated in FIG. 14, in a case where the partition plate 65 is attached to be disposed at the center of the left-right direction by the work of the service provider, the boundary position between the first play area and the second play area is set to be at the center in the left-right direction. In this case, as illustrated in FIG. 16A, the first play area PA1 and the second play area PA2 have the same size.

In a case where the partition plate 65 is attached by the work of the service provider, the prize-acquisition game device 1 according to one or more embodiments can also be configured to include a position detector that detects the position of the partition plate by detecting the attachment position in the left-right direction of the partition plate 65.

For example, the position detector may use an optical sensor as an example. The optical sensor detects the presence or absence of attachment of the partition plate 65 by using a light-emitting unit and a light-receiving unit, which are provided at the attachment position of the first prize placement portion 62 or the second prize placement portion 63.

In one or more embodiments, in a case where the partition plate 65 is disposed as illustrated in FIG. 14, it is assumed that the position detector detects the central attachment position "3" out of the five positions. The attachment position of "3" corresponds to the detection position of the partition plate 65 when the first play area on the left side and the second play area on the right side are set to have the same size.

In the disposition state illustrated in FIG. 14, the determination unit 110a determines (or sets) the detected position of the light-emitting unit 75 to be the boundary position associated with the detected "3", based on the detection position of the partition plate 65. That is, the determined boundary position is a boundary position when the first play area PA1 and the second play area PA2 are set to have the same size.

When the boundary position is set in this way, the light-emitting unit 75 changes the size of the first light-emitting area LA1 corresponding to the first play area on the left side and the second light-emitting area LA2 corresponding to the second play area on the right side so that they have the same size, as illustrated in FIG. 16B.

In addition, as illustrated in FIG. 15, in a case where the partition plate 65 is attached to a position offset in the left direction from the center of the left-right direction by the work of the service provider, the boundary position between the first play area and the second play area is changed to be disposed shifted in the left direction from the center in the left-right direction. In this case, as illustrated in FIG. 16C, the first play area PA1 is larger than the second play area PA2.

In one or more embodiments, in a case where the partition plate 65 is disposed as illustrated in FIG. 15, it is assumed that the position detector detects the central left attachment position "2" out of the five positions. The attachment position of "2" corresponds to the detection position of the partition plate 65 when the second play area on the right side is set to be larger than the first play area on the left side.

In the disposition state illustrated in FIG. 15, the determination unit 110a determines (or sets) the boundary position of the light-emitting unit 75 to be the boundary position associated with the detected "2" based on the detection position of the partition plate 65. That is, the determined boundary position is a boundary position when the second play area PA2 is set to be larger than the first play area PA1.

When the boundary position is set in this way, the light-emitting unit 75 changes the size of the first light-emitting area LA1 corresponding to the first play area and the second light-emitting area LA2 corresponding to the second play area so that the second light-emitting area LA2 is larger than the first light-emitting area LA1, as illustrated in FIG. 16D.

The light-emitting unit 75 in one or more embodiments can make the light emission color of the first light-emitting area LA1 corresponding to the first play area different from the light emission color of the second light-emitting area LA2 corresponding to the second play area.

In addition, the light-emitting unit 75 in one or more embodiments can make the light emission pattern of the first light-emitting area LA1 corresponding to the first play area different from the light emission pattern of the second light-emitting area LA2 corresponding to the second play area.

As described above, by making the light emission colors or light emission patterns of the first light-emitting area LA1 and the second light-emitting area LA2 different from each other, the size of each of the first play area and the second play area can be easily ascertained.

### Other Embodiments

The above embodiments are provided to facilitate understanding of the present invention, and are not to be construed as limiting the present invention. The present invention can be modified or improved without departing from the spirit thereof, and the present invention also includes equivalents thereof. In particular, the embodiments described below are also included in the present invention. In other words, the present invention can be configured by appropriately combining the above embodiments with the embodiment described below.

In addition, it is also possible to construct various inventions by appropriately combining multiple invention-defining matters disclosed in the above embodiments. For example, the invention may be constructed by deleting some of the invention-defining matters from all of the invention-defining matters disclosed in the above embodiment, or the invention may be constructed by appropriately combining all of the invention-defining matters disclosed in the above embodiment with the invention-defining matters disclosed in the embodiment described below.

### Movable actuator

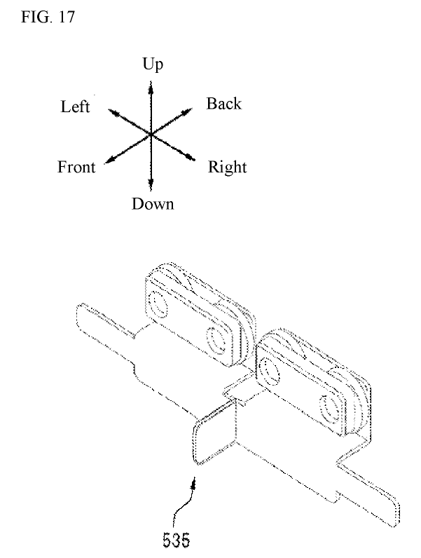

In the above embodiment, an example has been described in which the first right end actuator 532 (first actuator) and the second left end actuator 533 (second actuator) can each slide along the fixed rail 53a to change their left-right positions. However, the present invention is not limited to this. As illustrated in FIG. 17, an actuator 535 in which the first right end actuator 532 (first actuator) and the second left end actuator 533 (second actuator) are integrated may also be used.

In this case, the integrated actuator 535 is supported by the fixed rail 53a so as to be slidable between the first moving rail 54a1 and the second moving rail 54a2. In addition, the first right end sensor 54c2 (first sensor) and the second left end sensor 54c3 (second sensor) function as sensors that detect the boundary position between the first play area and the second play area. Therefore, the service provider can change the size of the first play area and the second play area at the same time by adjusting the position of the integrated actuator along the fixed rail 53a in the left-right direction.

In addition, in the above embodiment, an example has been described in which the first right end actuator 532 (first actuator) and the second left end actuator 533 (second actuator) each have two wheels, but the present invention is not limited to this. For example, the first right end actuator 532 (first actuator) and the second left end actuator 533 (second actuator), which do not have wheels, may each be configured to be slidably fitted into a groove on the inside of the front fixed rail 53a.

### Movable sensor

In the above embodiment, the first right end sensor 54c2 (first sensor) and the second left end sensor 54c3 (second sensor) may each be configured to slide along the fixed rail 53a to change their positions in the left-right direction.

In this case, a first right end actuator 532 (first actuator) is attached to the right front side of the first moving rail 54a1 in place of the first right end sensor 54c2, and a second left end actuator 533 (second actuator) is attached to the left front side of the second moving rail 54a2 in place of the second left end sensor 54c3. This enables the service provider to individually change the sizes of the first play area and the second play area by adjusting the left-right position of each of the first right end sensor 54c2 (first sensor) and the second left end sensor 54c3 (second sensor) along the fixed rail 53a.

It is noted that the first right end sensor 54c2 (first sensor) and the second left end sensor 54c3 (second sensor) may be integrated into one body.

### Position detector

The prize-acquisition game device 1 according to the above embodiment can also adopt a configuration including a position detector that detects the rightward movement limit position of the first prize-acquisition unit 20a in the first play area and the leftward movement limit position of the second prize-acquisition unit 20b in the second play area.

For example, the position detector can use an encoder as an example. In the first play area, by driving the first left-right moving motor 53b1, the first moving rail 54a1 can be moved along the fixed rail 53a. The encoder detects the number of rotations of the first left-right moving motor 53b1. Based on the output of this encoder, the position of the first moving rail 54a1 in the left-right direction (in other words, the position of the first prize-acquisition unit 20a in the left-right direction) can be detected In addition, in a case where the rightward movement limit position is set in advance in accordance with the size of the first play area, it is also possible to detect the rightward movement limit position of the first prize-acquisition unit 20a based on the output of this encoder.

In addition, in the second play area, by driving of the second left-right moving motor 53b2 in the same manner, the second moving rail 54a2 is moved along the fixed rail 53a in the left-right direction. The encoder detects the number of rotations of the second left-right moving motor 53b2. Based on the output of this encoder, the position of the second moving rail 54a2 in the left-right direction (in other words, the position of the second prize-acquisition unit 20b in the left-right direction) can be detected In addition, in a case where the leftward movement limit position is set in advance in accordance with the size of the second play area, it is also possible to detect the leftward movement limit position of movement of the second prize-acquisition unit 20b based on the output of this encoder.

In this case, the determination unit 110a can also determine the boundary position of the light-emitting unit 75 to be a boundary position when the first play area PA1 area and the second play area PA2 are set to have the same size or determine the boundary position thereof to be a boundary position when the second play area PA2 is set to be smaller than the first play area PA1, based on at least one detection position of the rightward movement limit position of the first prize-acquisition unit 20a and the leftward movement limit position of the second prize-acquisition unit 20b.

When the boundary position is set in this way, the light-emitting unit 75 changes the first light-emitting area LA1 corresponding to the first play area and the second light-emitting area LA2 corresponding to the second play area so that they have the same size, or changes the size of the second light-emitting area LA2 corresponding to the second play area to be smaller than that of the first light-emitting area LA1 corresponding to the first play area.

The light-emitting unit 75 in one or more embodiments can make the light emission color of the first light-emitting area LA1 corresponding to the first play area different from the light emission color of the second light-emitting area LA2 corresponding to the second play area.

In addition, the light-emitting unit 75 in one or more embodiments can make the light emission pattern of the first light-emitting area LA1 corresponding to the first play area different from the light emission pattern of the second light-emitting area LA2 corresponding to the second play area.

As described above, by making the light emission colors or light emission patterns of the first light-emitting area LA1 and the second light-emitting area LA2 different from each other, the size of each of the first play area and the second play area can be easily ascertained.

### Prize

In the above embodiment, the prizes housed in the casing 10 are not limited to items that the player can directly acquire (for example, stuffed toys or the like), but also include items that are housed as targets for acquisition in the game and can be exchanged for other prizes after acquisition, and items that are not provided themselves but are used to compete for points or rankings.

### Description of Reference Numerals

1 Prize-acquisition game device

10 Casing

11 Opening/closing door

12 Pillar portion

20 Prize-acquisition unit

20a First prize-acquisition unit

20b Second prize-acquisition unit

21 Base unit

22 Protruding portion

25 Arm portion

28 Arm linking portion

29 Arm

29A First arm

29B Second arm

29C Third arm

30 Claw

35 Drive unit

35A First drive unit

35Aa Arm opening/closing motor

35Ab Gearbox

35B Second drive unit

35Ba Arm opening/closing motor

35Bb Gearbox

35C Third drive unit

35Ca Arm opening/closing motor

35Cb Gearbox

50 Moving unit

51 Horizontal moving unit

52 Vertical moving unit

52a Lifting unit

52b Suspending unit

52b1 First suspending unit

52b2 Second suspending unit

52d1 First front-end sensor

52d3 Second front end sensor

53 Left-right moving unit

53a Fixed rail

53b Left-right moving motor

53b1 First left-right moving motor

53b2 Second left-right moving motor

54 Front-back moving unit

54a Moving rail

54a1 First moving rail

54a2 Second moving rail

54b Front-back moving motor

54b1 First front-back moving motor

54b2 Second front-back moving motor

54c1 First left end sensor

54c2 First right end sensor

54c3 Second left end sensor

54c4 Second right end sensor

60 Exhibit unit

61 Support portion

62 First prize placement portion

63 Second prize placement portion

65 Partition plate

71 Opening area

72 Drop port area

75 Light-emitting unit

80 Base unit

90 Operation unit

91 Joystick

92 Operation button

93 Play fee detection unit

94 Coin slot

96 Prize outlet

100 Setting unit

101 Setting operation unit

102 Display unit

110 Control unit

110a Determination unit

110b Display control unit

120 Storage unit

531 First left end actuator

532 First right end actuator

532a Shielding portion

532b Magnet

532c Wheel

532d Knob portion

533 Second left end actuator

533a Shielding portion

533b Magnet

533c Wheel

533d Knob portion

534 Second right end actuator

535 actuator

541 First front end actuator

542 First back end actuator

543 Second front end actuator

544 Second back end actuator

What is claimed is:

1. A prize-acquisition game device comprising:
a casing that houses prizes;
first and second prize catchers that are respectively disposed in a left-side first play area and a right-side second play area adjacent in a lateral direction within the casing and that acquire the housed prizes;
a central processing unit (CPU) that sets a boundary position between the first play area and the second play area based on a setting operation by an operator; and
an illumination device that emits light to a first light-emitting area corresponding to the first play area and a second light-emitting area corresponding to the second play area, and change the first light-emitting area and the second light-emitting area depending on the set boundary position.

2. A prize-acquisition game device comprising:
a casing that houses prizes;
first and second prize catchers that are respectively disposed in a left-side first play area and a right-side second play area adjacent in a lateral direction within the casing and that acquire the housed prizes;
a position detector that detects at least one of a right end position of the first play area and a left end position of the second play area;
a central processing unit (CPU) that sets a boundary position between the first play area and the second play area based on at least one of the right end position and the left end position; and
an illumination device that emits light to a first light-emitting area corresponding to the first play area and a second light-emitting area corresponding to the second play area, and change the first light-emitting area and the second light-emitting area depending on the set boundary position.

3. A prize-acquisition game device comprising:
a casing that houses prizes;
first and second prize catchers that are respectively disposed in a left-side first play area and a right-side second play area adjacent in a lateral direction within the casing and that acquire the housed prizes;
a position detector that detects a position of a partition plate disposed between the first play area and the second play area;
a central processing unit (CPU) that sets a boundary position between the first play area and the second play area based on the position of the partition plate; and
an illumination device that emits light to a first light-emitting area corresponding to the first play area and a second light-emitting area corresponding to the second play area, and changes the first light-emitting area and the second light-emitting area depending on the set boundary position.

4. A prize-acquisition game device comprising:
a casing that houses prizes;
first and second prize catchers that are respectively disposed in a left-side first play area and a right-side second play area adjacent in a lateral direction within the casing and that acquire the housed prizes;
a position detector that detects at least one of a rightward movement limit position of the first prize catcher in the first play area and a leftward movement limit position of the second prize catchers in the second play area;
a central processing unit (CPU) that sets a boundary position between the first play area and the second play area based on at least one of the movement limit positions of the first play area and the second play area; and
an illumination device that emits light to a first light-emitting area corresponding to the first play area and a second light-emitting area corresponding to the second play area, and changes the first light-emitting area and the second light-emitting area depending on the set boundary position.

5. The prize-acquisition game device according to claim 1, wherein
the illumination device emits light of a first emission color to the first light-emitting area corresponding to the first play area, the first emission color being different from a second emission color of light emitted to the second light-emitting area corresponding to the second play area.

6. The prize-acquisition game device according to claim 1, wherein
the illumination device emits light of a first emission pattern to the first light-emitting area corresponding to the first play area, the first emission pattern being different from a second emission pattern of light emitted to the second light-emitting area corresponding to the second play area.
